(19) United States
(12) Patent Application Publication
(10) Pub. No.: US 2009/0104581 A1
(43) Pub. Date: Apr. 23, 2009

(54) Dental Restoration Device

(76) Inventor: Denis Simon, Annecy-Le-Vieux (FR)

Correspondence Address: Fay Sharpe LLP, 1228 Euclid Avenue, 5th Floor, The Halle Building, Cleveland, OH, 44115, US

(21) Appl. No.: 11/792,736

(22) PCT Filed: Jun. 15, 2005
(86) PCT No.: PCT/FR05/01504

§ 371 Date: Sep. 10, 2008

(30) Foreign Application Priority Data
Dec. 8, 2004 (FR) 0413299

(51) Int. Cl. A61C 7/00

(52) U.S. Cl. 433/149

(57) ABSTRACT

A device for anatomically restoring a tooth having a proximal caries (5) made of an elastically deformable material. Two end units (2a, 2b) are connected by a vertical wall (3) whose height (hp) is greater than its thickness (e). The two end units are separable from each other by a pair of forceps (6). The vertical wall (3) is shaped in the form of a corner, the height thereof (hp) of which is sufficiently high in such a way that it forms an inter-dental partition for the proximal caries (5) when the end units (2a, 2b) are brought into contact with the walls of the tooth in front of the caries.

The present invention concerns a device for dental restoration, the device being intended to be used by dental surgeons.

The modern, and in particular, professional life, forces individuals to have a perfect physical presentation, as such the visits to dental surgeons is increasingly frequent. This is often to look at proximal caries and to reconstruct the tooth by filling the cavity. This filling, which was made by a dental metal amalgam, is now generally made of a composite material that the dentist polymerizes. The ideal, to set up this material, would be to use two corners between the teeth made of a transparent matrix of very low thickness. But the installation would be difficult and or not very certain position for obtaining a good result.

The device of this invention would solve the disadvantages of the traditional system thanks to simple, reliable, not very expensive, easy to install means.

Thus, according to the invention, the device, which is intended to be used at the time of the anatomical restoration of a tooth having proximal caries, is made of an elastically deformable material, and has two end-units connected by a vertical wall whose height is greater than its thickness. A device in which the two end-units are intended to be separated from each other by the vertical wall and is characterized in that the vertical wall has the shape of a corner; its height is sufficiently high to constitute by itself an inter-dental wall for the proximal caries such that the end-units are in contact with walls of the tooth with the proximal caries and those of the tooth next to the caries.

Thus, the solution according to the invention, essentially proposes a part forming an inter-dental elastic matrix which replaces all the former devices in which a general metal matrix is used with a particular elastic corner which comes to carry out the chock and wedging of the aforementioned matrix against the ed tooth. The advantages of this invention are numerous: installation of a single piece in only one movement to spread the spacing of the end-units with an already existing and easily available tool to a dental surgeon.

According to another complementary characteristic, the height of the vertical wall is equal to the height of the two end-units which have the same height as each other.

Let us add, that according to the preferred embodiment, the vertical wall has the shape of a corner, and is preferably formed of two curved concave surfaces which converge toward the top (HA).

According to the preferred embodiment of the invention, each unit is formed of an end wall with at least two different surfaces whose lower surface forms a chamfer.

Also according to the preferred embodiment, the top edge of the vertical wall constituted by a pointed edge making it possible to create the inter-dental point of contact, once finished with the dental restoration. If necessary, the dentist can put a restoration material directly on top of this edge which once solidified will constitute the inter-dental point or If need be to create a notch in the edge itself which will be filled directly with the restoration material.

Finally, according to the preferred embodiment, the device constitutes a single piece preferably made by injection molding.

It is understood that the device of the invention, also allows the user to slightly draw aside the two adjacent teeth with the aim of perfecting, after the removal of the matrix, the point of contact.

One will add that the device allows the dental surgeon, to create with the highest part of the vertical wall, a hole or a release, using a small cutter, in order to physically make the necessary point of contact between the two teeth.

Other characteristics and advantages of the invention will emerge from the description which follows as well as the annexed drawings which are given only by way of nonrestrictive examples.

FIG. 1 is a perspective view of a device according to the invention.

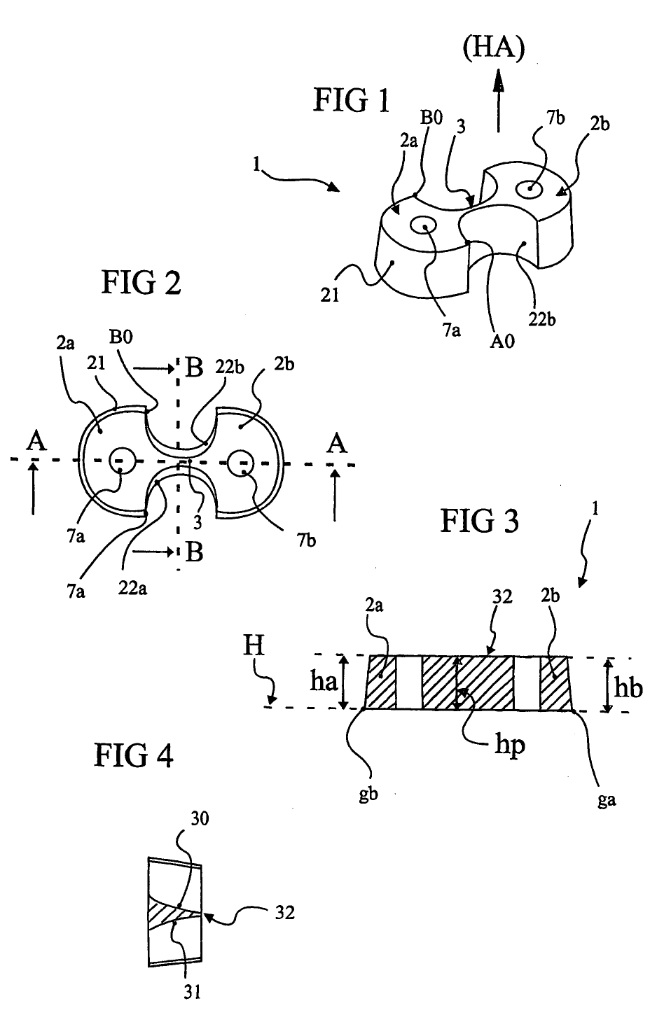

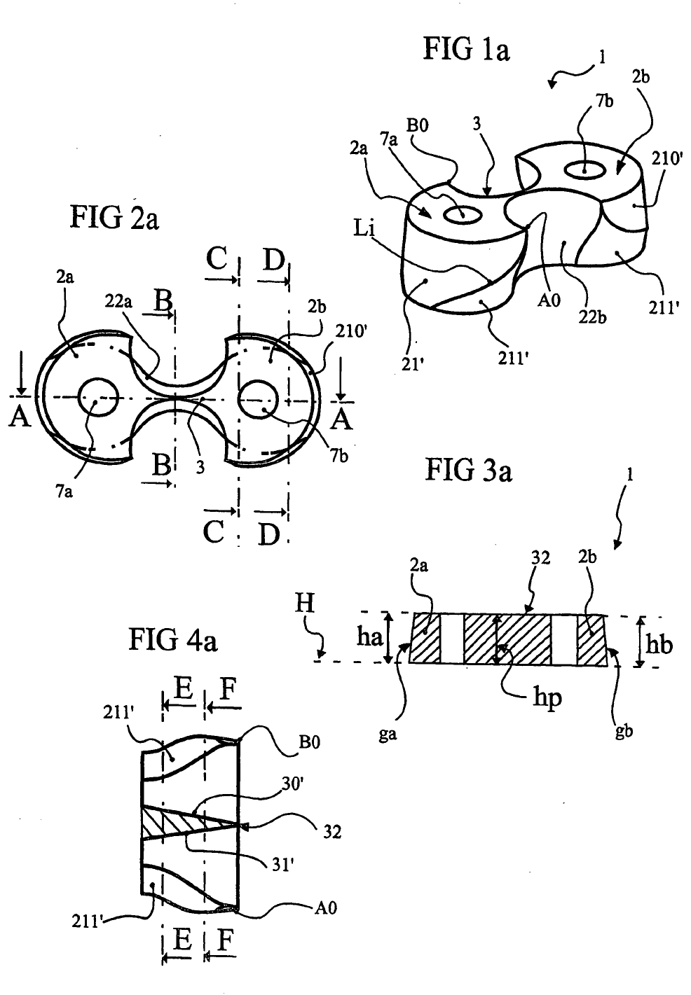

FIG. 2 is a top view.

FIG. 3 is a cross-sectional view along to A-A of FIG. 2.

FIG. 4 is a cross-sectional view along to B-B, of FIG. 2.

FIGS. 1a to 4a are views similar to those of FIGS. 1 to 4 but showing a device according to a preferred embodiment.

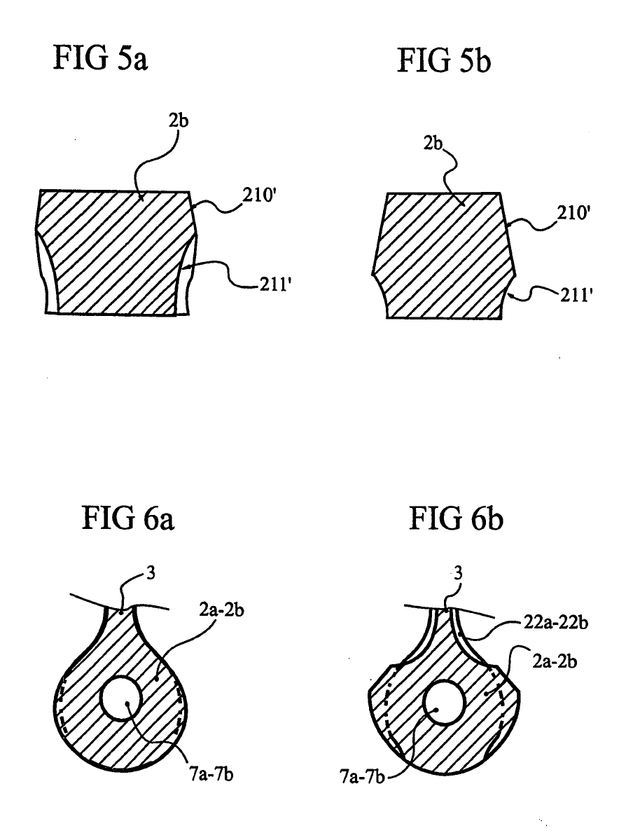

FIGS. 5a & 5b are vertical cross-sectional views along C-C, D-D, of the device according to the preferred embodiment of FIG. 1a.

FIGS. 6a, 6b are horizontal cross-sectional views along E-E, F-F, of the device according to the preferred embodiment of FIG. 1a.

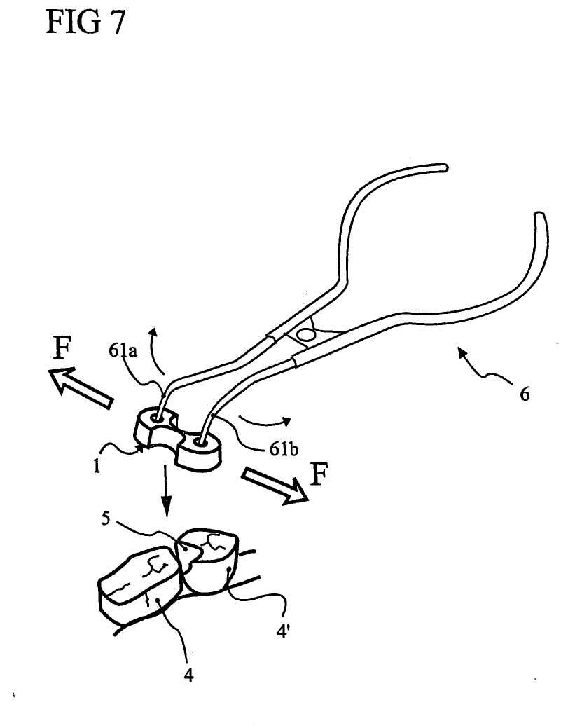

FIG. 7, is a view showing how to install the device according to the invention.

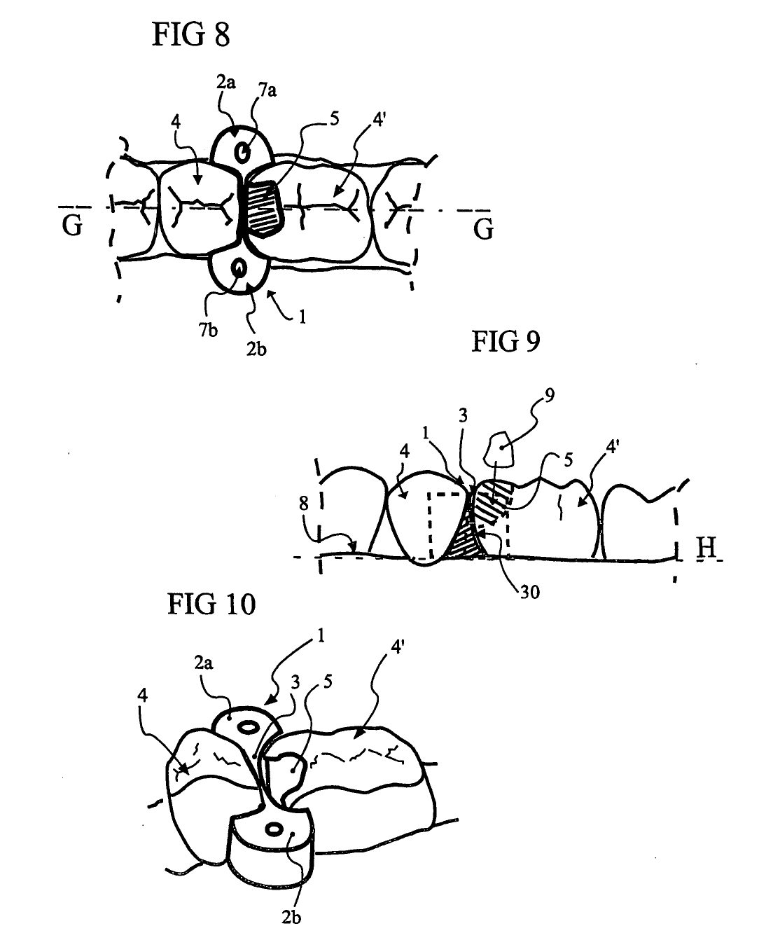

FIG. 8 is a top view, showing two teeth between which the device is put in place.

FIG. 9 is a cross-sectional view along G-G.

FIG. 10 is a perspective view showing two adjacent teeth.

The device indicated by the general reference, (1), is made of two end-units (2a, 2b) connected by a vertical wall (3).

According to a characteristic of the invention, the device (1) is made out of an elastic material such as elastomer, or any other similar material, such as latex. The elasticity of the material allows, as we will see, the deformation in extension of the piece at the time of the installation, and after which it returns.

The device (1) of the invention is intended to be used by dentists, for the restoration of one or more teeth (4, 4′). Thus it is put in place by the dentist, in the mouth of the patient, between two adjacent teeth of which, for example, one (4′) has (5) which must be filled after treatment with, for example, a composite material, such as a photopolymerizable composite, in order to reconstruct the tooth in three dimensions.

Thus, the device (1) of the invention is installed between the two teeth (4, 4′) so that the vertical wall (3) is engaged between the two teeth to be reconstructed, or between the tooth to be reconstructed and the adjacent tooth, such as is illustrated in FIGS. 7, 8, 9.

The installation of the device (1) is done by deforming the device (1) and in particular by its longitudinal extension. Thus, it is extended along F, by forceps (6) as illustrated in FIG. 6.

To this end, each of the end-units (2a, 2b) includes respectively a gripping hole (7a, 7b); each hole is intended to receive the ends (61a, 61b) of the forceps (6) for installation. After insertion, the device is inserted until the lower plane (H) of the device (1) is in contact with the gum (8). In this position, the installation tool Is removed, and the device (1) thanks to its elasticity is placed tightly between the teeth bringing together the two end-units (2a, 2b) which come in intimate contact with the walls of the teeth, such as that is illustrated in FIGS. 7, 8, 9. In this position, the vertical wall (3) of the device creates a wall between the teeth, constituting a wall for the proximal caries and an edge which forms with the hole from the a cavity for filling (50) having a peripheral wall, a cavity (50) that the dental surgeon will be able to fill with an anatomic repairing material (9).

As soon as the tooth is reconstructed and the composite material is polymerized, for example photo-polymerized, it is enough for the dentist to divide the device (1) and withdraw it.

According to a characteristic of the invention, the vertical wall (3) is such that its height (hp) is greater than its thickness (e). According to the preferred embodiment, the height (hp) of the vertical wall (3) is equal to the height of the two end-units (2a, 2b) which have the same height as each other. Thus, the height (ha) of the internal unit (2a) is equal to the height (hb) external unit (2b).

In addition, and as clearly appears in FIGS. 3 and 4, the vertical wall has the shape of a corner, i.e., it is formed by two concave curved surfaces (30, 31) which converge at the top, so that the thickness of the wall decreases as it approaches the top, until for example the upper edge (32) is constituted by a pointed edge without thickness, which makes it possible to create the point of contact between teeth once finished with the dental restoration. With its corner-like shape, the vertical wall (3) sits in place in the space between teeth perfectly, such as appears more particularly in FIG. 8.

It is understood in what precedes that the vertical connecting wall (3) extends to a height, on the top (hp) high enough to form by itself a wall for the caries and thus an edge (30), which forms with the hole from the a cavity (50) having a peripheral wall, which cavity (50) the dental surgeon will be able to fill with a anatomic repair material (9). The height (hp) of the vertical wall (3) is, for example, equal to the height of the end-units, and, for example, is between 1 and 8 millimeters, such as, for example, 3 millimeters.

It goes without saying that the height (hp) of the vertical wall (3) can be less than the height (ha) of the internal unit (2a) and/or that (hb) of the external unit (2b) but is still sufficiently high to form, once in a position of restoration and after elongation with the forceps, an edge (30) substantially the same height as the higher edge of the ed tooth before the was removed. Advantageously, in its correct positioning, i.e., when the device is no longer being stretched, the height (hp) of the vertical wall (3) is equal to at least 70% the height (ha, hb) of the end units (2a, 2b) the least important. Preferably, this height will be on the order of 90% the height (ha, hb) of the two units (2a, 2b) when the latter are of the same height.

Each of the units (2a, 2b) is made up of an end wall (21) with a single curved, convex surface, which extends up to two points of inflection (Ao and Bo), which are extended by the two concave side surfaces (22a, 22b) connecting the convex end walls (21) to the vertical wall (3). These two concave surfaces (22a, 22b) are intended to match the peripheral surface between the teeth. The end wall (21) has a single curved and convex surface for each unit (2a, 2b) convex around the line ga, gb is inclined toward the top (FIG. 3), the slope of the generated line, ga, of the interior unit (2a) is identical to the other gb of the external unit (2b). Also the two end-units, 2a, 2b, can be identical such as is illustrated, or different in their volume, dimensions, and/or their form.

FIGS. 1a to 4a and FIGS. 5a, 5b and 6a, 6b represent a preferred embodiment of the device according to the invention, in which the two end-units (2a, 2b) are identical but the end wall (21′) is different from the previously described end wall (21) which has a single curved and convex surface.

Indeed, this new end wall (21′) is also curved but has two different surfaces (210′, 211′): a curved and convex surface (210′) located at the top of a curved but concave surface (21′) (FIGS. 5a, 5b).

Thus, according to this embodiment, there are four angles of the lower part forming the base of each unit (2a, 2b) have to be removed and the lower surface (211′) forms a chamfer. The shape of the chamfer surface is curved and concave (FIG. 5a, 5b) and permits avoiding that the device according to the Invention Is not itself removed, in certain configurations, on the plane of the molars on which the operation of restoration is carried out. Obviously, this chamfer (211′) can have another surface: it can have a planar surface or a curved surface. This curved surface can be convex but with a convexity different from that of the upper surface (210′). This lower surface (211′) forming the chamfer (211′) of each unit (2a, 2b) is preferably made by removal of material by ratio with the upper surface. The choice of the trajectory of the line (Li) of separation between the top surface (210′) and the lower surface (211′) which form the chamfer, as well as, the choice between a planar surface or the curved surface (211′) will be determined In a manner so as to match the profile between the teeth with that of the device according to the invention as well as possible. The installation of the device (1) is thus largely improved.

The vertical wall (3′) has in this preferred embodiment the form of a triangular corner at the plane of the axis of symmetry (B-B) of the device (FIG. 4a), i.e. it is formed by two parallel surfaces (30′, 31′) which converge toward the top, so that the thickness of the wall decreases toward the top, until for example the upper edge (32) is a point without thickness, which also makes it possible to create the point of contact between teeth once finished with the dental restoration. Of course, the invention is not limited to the embodiments described and represented by way of examples, but it includes also all the technical equivalents and their combinations.

To some extent, the invention as illustrated and the preferred embodiment, primarily propose an elastic matrix between teeth produced as a single part which is preferably made by injection molding.

1. A device for use during an anatomical restoration of a tooth having proximal caries, the device being made of an elastically deformable material and including two end-units connected by a vertical wall, a height of which is greater than its thickness, the two end-units of the device being configured to be spread from each other by arms of a dental tool wherein the vertical wall height is sufficiently high to create an inter-dental wall, next to a proximal caries, when the end-units are in contact with walls of the tooth adjacent the proximal caries and next to the proximal caries.

2. The device according to claim 1, wherein the height of the vertical wall is equal to a height of the two end-units, the two end-units being the same height.

3. The device according to claim 1, wherein the vertical wall is formed by two concave curved surfaces which converge at the top.

4. The device according to claim 1, wherein the vertical wall is formed by two parallel surfaces converging toward the top.

5. The device according to claim 1, wherein each end-unit is made of an end wall which has a single curved and convex surface, the curved and convex surface extending up to two points of inflection, two concave side surfaces connecting the end wall to the vertical wall.

6. The device according to claim 1, wherein each of the end-units is formed by an end wall with at least two different surfaces having a lower of the surfaces forming a chamfer.

7. The device according to claim 1, wherein the device is constructed of an elastomer or latex.

8. The device according to claim 1, wherein an upper edge of the vertical wall is a pointed edge which makes it possible to create an inter-dental point of contact, after the dental restoration.

9. The device according to claim 1, wherein the device is a single piece.

10. A dental restoration device comprising:
a pair of end units configured to engage peripheral walls of a pair of adjacent teeth;
a vertical wall extending between the end units, the vertical wall being configured to define a partition between the pair of adjacent teeth.

11. The device according to claim 10, wherein the end-units and the vertical wall are an integral, elastomic construction.

12. The device according to claim 11, wherein the end-units and the vertical wall have a common height.

13. The device according to claim 12, further including curved surfaces connecting the end units and the vertical wall.

14. The device according to claim 12, wherein the vertical wall converges toward a top.

15. The device according to claim 12, wherein the vertical wall converges to a sharp edge.

16. The device according to claim 11, wherein the end-units are configured to be engaged by a surgical instrument to stretch the vertical wall to facilitate insertion between the pair of adjacent teeth.
